(19) United States
(12) Patent Application Publication
(10) Pub. No.: US 2014/0263776 A1
(43) Pub. Date: Sep. 18, 2014

(54) Apparatus and Method for Packaging a Granulated Composition of Matter

(71) Applicant: Francesco Bottura, Nyon (CH)

(72) Inventor: Francesco Bottura, Nyon (CH)

(73) Assignee: Eco-Care Holding SA, Etoy (CH)

(21) Appl. No.: 14/212,245

(22) Filed: Mar. 14, 2014

(30) Foreign Application Priority Data
Mar. 14, 2013 (EP) 13159271.9
Apr. 23, 2013 (EP) 13164928.7

(51) Int. Cl. B02C 18/08; B02C 23/18; B02C 18/22; B02C 23/24

(52) U.S. Cl. CPC B02C 18/08; B02C 23/24; B02C 23/18; B02C 18/22
USPC 241/28; 241/278.2; 241/47; 241/38; 241/30

(57) ABSTRACT

The present invention relates,
to a device for conditioning as granules a composition formulated from organic and mineral raw materials, characterized in that it comprises a rotary tank with a hyperbolic or exponential wall receiving the bulk raw materials in the upper portion, at least one set of blades ensuring the mixing and milling of said materials inside the tank and a helical groove borne by the wall of said tank and ensuring together delivery by centrifugation and guiding of the mixture from the low portion of the tank to its upper portion and gradual agglomeration of said materials in granules, on the one hand and,
to a method for conditioning said composition by means of said device, on the other hand.

The present invention relates to a device for conditioning in granules a material composition as well as to a method for conditioning such a composition.

The present invention more particularly relates to a device and to a method intended for conditioning in the form of solid particles, organic raw materials or a set of organic and mineral raw materials entering the formulation of a snow removal flux and in particular a biodegradable snow removal flux.

Document FR 1 158 069 describes a flux composition intended for removing snow and/or thawing the ground, and more particularly highways and road traffic lanes. This composition is obtained by milling and mixing different organic and/or mineral materials which are then agglomerated so as to preferably appear in the final compact form of ready-to-use granules.

There already exist devices giving the possibility of carrying out operations for preparing and conditioning chemical compositions of this type. However, these devices generally consist of a series of independent mechanical and hydraulic means which are connected in a chain in a functional way and which each carry out one isolated and well-determined operation of the formulation method.

The successive operations comprise the milling, homogenization and mixing of materials of organic origin and/or of materials of mineral origin and of a binder, preferably a hydraulic binder and of natural origin. The obtained mixture is then subject to an agglomeration and compaction step and is then subject to a drying step.

This division of the operations, in addition to the difficulties of application on several pieces of equipment, is all the more penalizing since certain compositions including that of the flux are aimed at being prepared on the actual location of their use, for example, by spraying for avoiding significant logistic costs (transport . . . ).

Now, the existing installations are not adapted to such delocalizations which necessarily involve great mobility and therefore increased compactness and autonomy.

The object of the present invention is to solve the technical problems, satisfactorily and efficiently, by proposing a solution giving the possibility of achieving all the phases of the formulation and conditioning of these compositions by means of a single and unique compact device.

This object is achieved according to the invention by means of a conditioning device, characterized in that it comprises a rotary tank with an inner wall shaped as a funnel having a lower portion with a steep slope and a flared upper portion, receiving the bulk raw materials in the upper portion, at least a set of blades ensuring the milling and mixing of said materials inside the tank and at least one helical groove borne by said inner wall of said tank and ensuring together delivery by centrifugation and guiding of the mixture from the lower portion of the tank to its upper portion and gradual agglomeration of said materials in granules.

According to an embodiment, said inner wall has a continuously variable curvature and has a shape selected from axisymmetrical hyperboloids and exponential horns.

According to an advantageous feature, the device comprises, at the periphery of its upper portion, a conduit for extracting said materials agglomerated in granules.

According to another feature, the extraction member comprises a nozzle, in the tank, for blowing an air flow intended for drying said granules.

Preferably, said nozzle is associated with elements for heating the blown air flow.

According to an advantageous alternative, the set of blades is supported by a rotary shaft positioned along the central axis of the tank.

According to another feature, the device comprises, in the upper portion, an arm for scraping the internal wall of the tank.

According to another alternative, the device comprises two sets of blades respectively borne by two independent coaxial shafts which are driven into rotation in opposite directions.

According to yet another feature, the device comprises an endpiece, in said tank for injecting a liquid constituent.

Further, the device comprises an upper hopper for supplying raw materials.

If necessary, the device comprises a member for sampling and treating the exhaust gases of the tank.

According to a specific embodiment, the device comprises a hood, over its perimeter, fitting the profile of the upper edge of the tank by making an interstitial space forming a conduit for extracting the granules and being engaged, in its simple portion, and protruding inside said tank.

According to an embodiment, the device comprises pivoting means giving the possibility of varying the tilt angle of the axis of rotation of the tank relatively to the vertical.

Another object of the invention is a method for conditioning a flux composition into granules by means of the device defined above.

In particular, an object of the invention is a method as above wherein said flux composition comprises a majority portion of biodegradable raw materials of plant origin and a minority portion of salts selected from organic salts and mineral salts of alkaline and/or earth alkaline metals, and in particular a composition comprising 71-90% of biomass and 10-29% of said salts. The composition may include 4-10% of binder.

Another object of the invention is a snow removal flux obtained by a method as above.

The device of the invention is intended to be preferably used in a moveable way by being loaded into a utility vehicle which moves over the ground or the snow removal site to be treated.

However, the device of the invention may actually just as well be used in a fixed industrial installation, for example, by substantially increasing its dimensions and by associating it, in parallel, with identical or similar devices for ensuring mass production.

The invention will be better understood upon reading the description which follows, accompanied with drawings wherein;

FIG. 1 illustrates a partial sectional schematic view of an embodiment of the invention.

FIG. 2 illustrates a partial sectional schematic view of an alternative embodiment of the invention.

FIG. 3 illustrates a partial sectional schematic view of another alternative embodiment of the invention.

The device illustrated in the figures is intended to be applied to a method for conditioning a biodegradable chemical composition used in a snow removal flux.

Such compositions which are notably described in FR 1 158 069, allow, associated with water in the ice/snow condition, its freezing temperature to be lowered.

The organic materials are preferably plant materials and are extracted, by any known method, from proteo-oleaginous species (sunflower, rape, pips/pulps of grapes . . . ) or from cereal (wheat, maize, miscanthus) waste. The mineral materials consists of salts (e.g. sodium, calcium, potassium, magnesium chlorides, . . . ) in solid form (grains) or in viscous form (brine) while the binder is an agricultural byproduct (stillage, molasses, . . . ).

The particles from these steps, which typically have a grain size comprised between 0.5 and 5 mm are then at least partly dried, and conditioned in the form of granules for which the humidity level is less than 10%.

These granules are either used in an independent form in spraying, or are associated with or incorporated into more complex formulations as an active agent, delaying freezing or as an accelerator/catalyst for thawing.

According to the invention, the device for conditioning the aforementioned compositions comprises a tank 1 with hyperbolic walls which are set into rotation at a high speed with a motor M.

The capacity of the tank 1 is generally comprised between 300 and 2,000 liters at an industrial scale. The speed of rotation of the tank, selected according to the raw materials, is of the order of a few meters/second, 0.5 and 15 m/sec at the level of the edge of the tank.

The ratio between the minimum diameter of the tank in its lower portion and the maximum diameter of the upper portion of the funnel is comprised between 1:7 and 1:20 and is preferably of the order of 1:12.

The ratio between the height of the tank and the maximum diameter of the upper portion of the funnel is comprised between 0.7:1 and 1:1 and is preferably of the order of 0.85:1.

The maximum tilt of the wall in the lower portion is of the order of 75°-85° (aperture angle of the cone 10°-30°). The minimum tilt of the wall in the upper portion is in the order of 5°-15° (aperture angle of the cone 150°-170°).

For facilitating the upward movement of the products along the inner wall of the tank and their extraction, or even for varying the dwelling time of the materials in the tank, the axis of rotation of the tank is advantageously tilted by 15° to 30° relatively to the vertical. This may be achieved by mounting the pivoting tank in a frame (not shown in the figures).

The tank 1 thus has the general shape of a basin with a flared upper aperture, the convex flanks of which have a curvature comprised between 165° and 178° (almost horizontal at the upper aperture).

The bottom of the tank 1, as for it, has a diameter of about 5-20% of the upper diameter.

The tank 1 is in direct contact with the shaft of the motor M or driven into rotation via a transmission belt T, as illustrated by FIG. 1.

The tank 1 receives the organic and mineral raw materials in the upper portion via at least one supply hopper 2.

The materials of organic origin and those of mineral origin are introduced in bulk into the tank via distinct hoppers, in particular, if the organic materials are solid whereas the mineral materials are in a liquid or viscous phase.

However, it is also possible to provide that the organic and mineral materials be all mixed upstream from the hopper 2.

The tank 1 is equipped with at least one set of blades 3 ensuring the milling, mixing and homogenization of the materials inside the tank.

This set of blades is supported by a rotary shaft 31 positioned along the central axis of the tank 1 and driven by a single motor m (FIG. 1).

In order to improve the mixing, the tank will be provided with two sets of blades 3a, 3b respectively borne by two independent coaxial shafts 31a, 31b.

Under these conditions, each of the shafts 31a, 31b is driven into rotation by its own motor ma, mb and both shafts are coupled, so as to rotate in opposite directions, via a universal joint 32 (FIG. 3), optionally associated with a differential, if different speeds of rotation proved to be useful.

The blades are configured as a comb or a rake while being secured to transverse branches connected to the shaft 31 so as to knead and stir the mixture in depth.

The profile and the dimensions of the blades are adapted, according to the different vertical areas of the tank, to the rheological properties of the mixture (density, viscosity, . . . ) at each area in order to perfect its homogenization.

The tank 1 further includes a helical groove 10 borne by the internal wall of said tank (FIG. 1) and ensuring together, delivery by a centrifugation effect and guiding of the mixture from the lower portion of the tank to its upper portion like a ramp and gradually agglomerating, along this ramp, the different materials into homogeneous granules g.

The pitch and the tilt of the helical groove 10 will be determined according to the position of the blade 3 in order to avoid any detrimental interaction.

The tank 1 comprises, at the periphery of its upper portion, a conduit 11 for extracting the granules. The rotation of the tank combined with the guiding action of the groove 10 causes an upward movement of the mixture which is gradually divided while it ascends, by agglomeration, while forming individualized particles.

These particles are thus again found, under the action of the centrifugal force, displaced to the upper periphery of the tank where they are extracted via the conduit 11 and transferred to a storage location by means of a conveyor C (FIGS. 1 and 2).

The conduit 11 is advantageously associated with a nozzle 4 for blowing an air flow (FIG. 2) allowing the drying of the granules g during the final phase of their extraction.

Preferably, the nozzle 4 is associated with elements (not shown) for heating the blown air flow in order to improve the drying rate.

In order to detach the few granules which would remain attached to the wall of the tank 1, the latter is provided in the upper portion with an arm 5 for scraping the internal wall of the tank. This arm 5, which is fixed, substantially fits the profile of the internal edge of the rotary tank 1.

The device comprises an end piece 6 for injecting into the tank 1 a liquid or semi-liquid constituent such as the binder of natural origin used for the formulation of a biodegradable chemical composition.

A member 7 for sampling and treating the exhaust gases from the mixture of the organic and mineral materials is also mounted on the tank in order to meet environmental standards. This member 7 is, if necessary, provided with suction means for facilitating the sampling flow rate of the gases to be treated.

According to an alternative, provision is made for laying on the tank 1 a hood 8 (FIG. 2) fitting, on its perimeter 8a, the profile of the upper edge.

An interstitial space is made between the hood 8 and the upper edge of the tank 1 in order to form the conduit 11 for extracting the granules g.

In its central portion 8b, the hood 8 has an obturating planar wall, slightly driven into the inside of the tank and through which the supply hopper 2 as well as the end piece 6 and the exhaust conduits of the treatment member 7 pass.

### EXAMPLE 1

A snow removal flux obtained by applying a device according to the invention comprises 72% of biodegradable organic materials of plant origin, and 28% of alkaline and/or earth alkaline salts.

### EXAMPLE 2

A snow removal flux obtained by applying a device according to the invention comprises 72% of biodegradable organic materials of plant origin, and 28% of organic salts, such as for example formates and/or acetates of alkaline and/or earth alkaline metals.

Examples of suitable plant materials are given hereafter:

### EXAMPLE 3

### Miscanthus (Miscanthus giganteus)

Portion used: Stems in sections/pieces with a length of 3 cm. They are finely milled into a powder, then mixed with sodium chloride or other suitable salts for snow removal as well with a binding substance such as molasses, stillage or other organic binder which reinforces the agglomeration and/or the granulation of the mixture.

### EXAMPLE 4

### Rape

Portion used: The powdery straw (stem) of chopped/finely milled rape, then mixed with sodium chloride or other suitable salts for snow removal as well as with a binding substance such as molasses, stillage or another organic binder which reinforces agglomeration and/or granulation of the mixture.

### EXAMPLE 5

### Maize

Portion used: The stems and the dry leaves of maize in sections/pieces with a length of 3 cm finely milled into a powder, then mixed with sodium chloride or other suitable salts for snow removal as well as with a binding substance, such as molasses, stillage or another organic binder which reinforces the agglomeration and/or granulation of the mixture.

### EXAMPLE 6

### Grapes

Portion used: The residues from the harvesting and pressing of the grains, such as clusters, pulps and remainders of grape pips after extracting the oil. These different residues may be used alone or as a mixture in the form of a grape marc compost. They are milled, sifted or ground, and then dried down to a humidity level of 6%, and then mixed with sodium chloride or other suitable salts for snow removal, as well as with a binding substance such as molasses, stillage or another organic binder which reinforces agglomeration and/or granulation of the mixture.

1. A device for conditioning as granules a material composition formulated from organic raw materials or from a set of organic and mineral raw materials, wherein it comprises a rotary tank with an inner wall shaped as a funnel with a lower portion with a steep slope and an upper flared portion receiving the bulk raw materials in the upper portion, at least one set of blades ensuring milling and mixing of said materials inside the tank and at least one helical groove borne by said inner wall of said tank and ensuring, together, delivery by centrifugation and guiding of the mixture from the lower portion of the tank to its upper portion and gradual agglomeration of said materials into granules.

2. The device according to claim 1, wherein said inner wall has a continuously variable curvature and has a shape selected from axisymmetrical hyperboloids and exponential funnels.

3. The device according to claim 1, wherein it comprises, at the periphery of its other portion, a conduit for extracting said granules.

4. The device according to claim 3, wherein said extraction conduit is associated with a nozzle for blowing an air flow intended for drying said granules.

5. The device according to claim 4, wherein said nozzle is associated with elements for heating the blown air flow.

6. The device according to claim 1, wherein the set of blades is supported by a rotary shaft positioned along the central axis of the tank.

7. The device according to claim 1, wherein it comprises, in the upper portion, an arm for scraping the internal wall of the tank.

8. The device according to claim 1, wherein it comprises two sets of blades respectively borne by two independent coaxial shafts which are driven into rotation in opposite directions.

9. The device according to claim 1, wherein it comprises an endpiece for injecting into said tank a liquid constituent.

10. The device according to claim 1, wherein it comprises an upper hopper for supplying raw materials.

11. The device according to claim 1, wherein it comprises a member for sampling and treating the exhaust gases of the tank.

12. The device according to claim 1, wherein it comprises a hood, on its perimeter, fitting the profile of the upper edge of the tank by making an interstitial space forming a conduit for extracting the granules and being engaged, in its central portion, protruding into the inside of said tank.

13. The device according to claim 1, wherein it comprises pivoting means allowing the tilt angle of the axis of rotation of the tank to be varied relatively to the vertical.

14. A method for conditioning as granules, a composition of snow removal flux, wherein it comprises the use of a device according to claim 1.

15. The method according to claim 14, wherein said flux composition comprises a majority portion of biodegradable raw materials of plant origin and a minority portion of salts selected from organic salts and mineral salts of alkaline and/or earth alkaline metals.

16. The method according to claim 15, wherein said flux compositions comprises 71-90% of biomass and 10-29% of said salts.

17. The method according to claim 15, wherein said flux composition comprises 4-10% of binder.

18. The method according to claim 14, wherein said raw material of plant origin is selected from miscanthus stems, rape straw, dry stems and leaves of maize, residues from the harvesting and pressing of grape pips, in particular clusters, pulps and remainders of grape pips after extracting the oil.
